(19) United States
(12) Patent Application Publication
(10) Pub. No.: US 2008/0071619 A1
(43) Pub. Date: Mar. 20, 2008

(54) ALTERNATIVE PAYMENT SYSTEM AND METHOD

(76) Inventors: DON CHARLTON, Crownsville, MD (US); Robert Jewell, Washington, DC (US); Eddy Simmons, Richmond, VA (US); Portman Wills, Springfield, VA (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/855,530

(22) Filed: Sep. 14, 2007

Related U.S. Application Data
(60) Provisional application No. 60/825,645, filed on Sep. 14, 2006.

(51) Int. Cl. G06Q 30/00; G06F 17/30

(52) U.S. Cl. 705/14; 705/27; 705/39

(57) ABSTRACT

A system and method, including offering to a customer as a part of a purchase transaction an option of completing an activity in exchange for a reduction in a purchase price, and targeting offers of such activities based on the interested customer.

### CROSS-REFERENCE TO RELATED APPLICATIONS

This application claims the benefit under 35 U.S.C. 119(e) of U.S. Application Ser. No. 60/825,645 entitled “Alternative Payment Apparatus and Method,” filed Sep. 14, 2006, which is incorporated herein by reference.

### FIELD OF INVENTION

The invention relates generally to a system and method for electronic commerce transactions, and more particularly to a system and method for offering services and/or products for a reduced price via the Internet.

### BACKGROUND

The use of the Internet as an electronic marketplace has steadily increased, and the Internet has the potential to become an even more efficient infrastructure for transactions relating to goods and services. The general realization of this fact has led to an increase in methods among vendors for advertising goods and services in an effective manner. A challenge is to target offers for goods and services at the potential customers who will potentially be most interested in the offering. Thus, there is a need for a tailored way to present offers for goods and services to prospective customers.

In addition, the advent and evolution of e-commerce has begun to bring the limitations of traditional currency-based transactions into sharp relief. Vendors would like to be able to offer goods and services to potential customers while being free from the potential limitations hindering such transactions presented by differences in currencies, or the availability of and access to complicated, potentially insecure, or unstandardized alternative payment systems such as credit cards, electronic funds transfers, or other current e-payment systems. Therefore, there is a need for a system of payment that is free of currency, standardization, and security limitations.

### SUMMARY OF THE INVENTION

A method includes a retailer offering to a customer an option of completing an activity in exchange for a reduction in the price associated with a purchase transaction. The retailer can receive a redemption authorization from an advertiser to enable redemption of a good or service earned through completion of the activity.

### BRIEF DESCRIPTION OF THE DRAWINGS

FIG. 1 is a flowchart that illustrates a method of alternative payment according to an embodiment of the invention.

FIG. 2 is a flowchart that illustrates a method for purchase and alternative payment according to an embodiment of the invention.

FIG. 3 is a flowchart that shows a method of protected alternative payment according to an embodiment of the invention.

FIG. 4 is a flowchart that shows a method of providing products and services for sale to customers via alternative payment, according to an embodiment of the invention.

FIG. 5 is a flowchart that illustrates a method of targeted commerce including alternative payment according to an embodiment of the invention.

FIG. 6 is a flowchart that illustrates a method of targeted commerce including alternative payment and credit accumulation according to an embodiment of the invention.

FIG. 7 is a flowchart that illustrates a method of targeted commerce including alternative payment and information feedback according to an embodiment of the invention.

FIG. 8 is a flowchart that illustrates a method of targeted commerce including alternative and referral-based payment, according to an embodiment of the invention.

FIG. 9 is a functional block diagram according to an alternative embodiment of the invention.

FIGS. 10 and 11 are flowcharts that illustrate a method according to an embodiment of the invention.

FIGS. 12A-12D are examples of graphical user interfaces including text messages according to an embodiment of the invention.

FIG. 13 is a flowchart that illustrates a method according to an embodiment of the invention.

FIGS. 14A-14B are examples of graphical user interfaces including text messages according to an embodiment of the invention.

FIG. 15 is a flowchart that illustrates a method according to an embodiment of the invention.

FIGS. 16A-16B are examples of graphical user interfaces including text messages according to an embodiment of the invention.

FIG. 17 is a schematic flow chart according to an embodiment of the invention.

FIGS. 18-30 are examples of Graphical User Interfaces (GUI) according to embodiments of the invention.

### DETAILED DESCRIPTION

A system and method is disclosed according to which customers can obtain goods and services using an alternative payment system. For example, when a customer purchases a product or service through a participating on-line retailer, the customer can opt to “pay” for the product or service by, for example, completing advertising offers, referrals, surveys, subscription opportunities, and credit card offers. Once the customer chooses this alternative payment method, he or she can be directed to the alternative payment site to complete various transaction(s).

At the alternative payment site, the customer can be presented with a variety of advertising offers to complete, or have completed, as a way of “paying” for the product he or she purchased through the retailer. For example, the customer can choose to complete a survey or sign up for a magazine subscription, or complete some other similar transaction. In some embodiments, the advertising offers can be associated with advertisers affiliated with the alternative payment site. Once that transaction is complete, the alternative payment site can make payment to the retailer on behalf of the customer and/or the customer can be provided with a coupon or authorization code to give to the retailer. The payment site can receive a commission from the affiliated advertiser as a result of the customer completing the particular advertising offer.

A customer can also choose to refer advertising offers to others for completion. For example, a customer can provide contact information for a friend, colleague, family members, or other acquaintance to the alternative payment site or affiliated advertiser. One or more selected advertising offers can then be sent to that person (“referral user”). A customer can enter one or more types of contact information for a referral user, such as a telephone number, email address, and/or a postal address, at which the referral user can be contacted by an advertiser and/or by the alternative payment site to complete, for example, an advertising offer. A customer can also specify, for example, a note, an invitation, encouragement or other request, to be included with any advertising offers to be sent to a referral user. The alternative payment site may offer a default note to be sent to a referral user.

Upon receiving a referred advertising offer (“referral offer”), a referral user can choose to complete or ignore the referral offer. A customer can choose to send multiple referral offers to a single referral user, and can choose to send a referral offer to multiple referral users. If the referral user completes a received referral offer, the advertiser can send a notification to the alternative payment site, indicating the referral offer that was completed and on whose behalf it was completed (the identity of the customer who referred the referral offer to the completing referral user). A value associated with the completion of the referral offer by the referral user can be credited to the account of the customer, for example to be applied toward his or her purchase of a selected item, product, or service or applied toward the receipt of a pre-selected item. This credit can be combined with the value of advertising offers completed by the customer, and/or combined with direct payments made by the customer, for example with a credit card or other direct payment method.

In another embodiment, a customer can be offered a choice of an available “free” or reduced-price product or service. Each free or reduced-price product or service can be associated with advertising offers or separate third-party sites to which a customer can go to complete an activity to earn the free or reduced-price product or service desired. Alternatively, the customer can choose a third-party site to visit and find out what free or reduced-price product or service he or she can obtain by completing a corresponding activity. The offers and third party sites can be tailored toward individuals based on their demographics (e.g., sex, age), specified preferences (e.g., sports, traveling), and/or based on their geographic location.

The demographics can be optimized over time by evaluating a greater degree of possible demographic categories. For example, as the system obtains more demographic information about a person or the person's purchasing habits, the offers/advertisements can be tailored more efficiently. For example, if a user indicates via a user profile that they are interested in “sports” they may receive advertising about multiple sports (e.g., soccer, football, baseball, tennis, etc.). Over time, if the user only ever views or purchases items related to baseball and football, the advertising or offers to which they are ultimately exposed may be more tailored. Said another way, the system “learns” what the user's preferences are over time and will tailor the demographic-based advertising and offers such that it is more finely tuned to an individual's preferences.

In addition, a customer can refer an advertising offer to a referral user for completion, upon the completion of which an associated credit can be credited to the customer's account and applied toward the purchase of a previously-selected product or service. The associated credit can be combined with other credits generated, for example, from the customer's own completion of advertising offers, or direct payments made by the customer, for example by credit card or other payment method. A customer can pre-select an item or a service the customer desires, and then when sufficient credits are accumulated, the customer can be notified that he or she is eligible to purchase the particular pre-selected item or service.

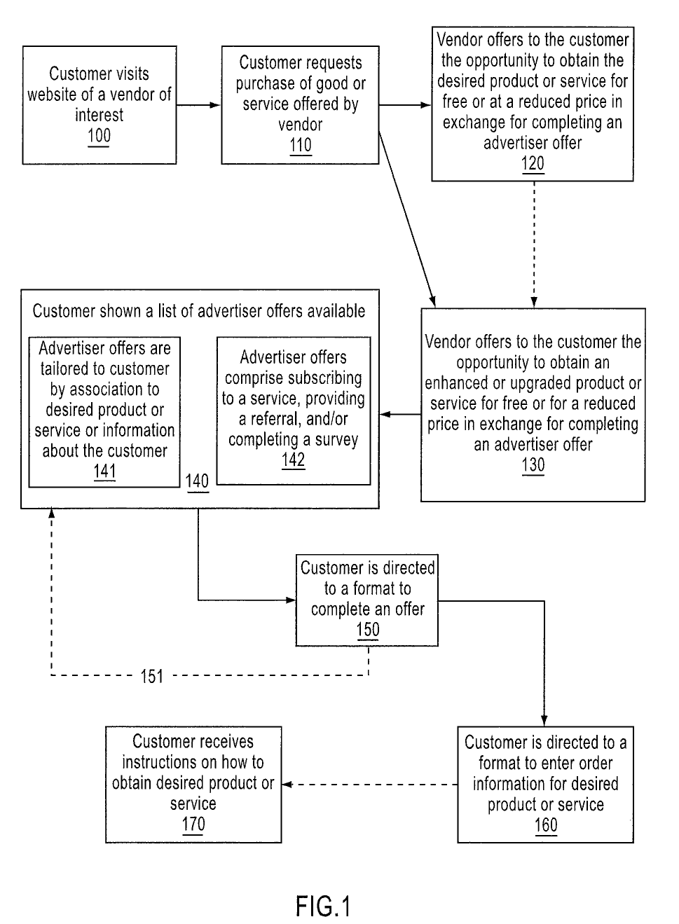

FIG. 1 is a block flow diagram that illustrates an embodiment of the invention. As illustrated at 100, a customer can visit a website of a participating vendor (“vendor”). The customer can select a product or service from the vendor's offering, and can request purchase of the good or service, 110. The vendor can then offer to the customer the opportunity to purchase the good or service at a reduced price, or for free, in exchange for completing an advertiser offer, 120. The vendor can also offer to the customer the opportunity to obtain an enhanced or upgraded version of the good or service at no additional cost or for a reduced price in exchange for completing an advertiser offer, 130. The advertiser offers can be provided to the vendor by a referral-based payment service provider.

The customer can be shown a list of the available advertiser offers, 140. The customer can be offered a choice between several advertiser offers, for example between 1 and 1000 advertiser offers, more narrowly between 2 and 50, and for example 10 advertiser offers. The advertiser offers can be tailored to the customer's interests as discussed above, 141. This can be effected by selecting the advertising offers to present to the customer based on the product or service the customer has requested, or based upon other information known about the customer, 141. Such other information known about the customer can be based on historical data relating to the customer, collected while the customer shopped with the vendor, either during or the instant transaction or previously. Such other information can also be based upon answers to questions presented to the customer during the course of the instant transaction or previously during a customer account or profile setup. Advertising offers can comprise subscribing to a service offered by an advertiser, providing a referral, completing a survey, other offers of advertisers, or any combination thereof, 142.

The customer can be directed to a particular format to complete the offer, 150. Upon completion of the offer, the customer can again be given the opportunity to select a second, third, or additional offer, as indicated by arrow 151, to further reduce the price the customer must pay for a desired product or service. The customer can be given the opportunity to complete a third or additional offer in order to be able to obtain a desired product or service at a reduced cost. In some embodiments a reduced cost includes reduction of the cost by 100% (e.g., the customer receives the item for free).

Upon completion of one or more offers, the customer can be directed to an interface to complete the order process for the desired product or service, 160. The customer can optionally be provided with instructions to enable the customer to obtain the desired product or service, for example, a key number, a personal identification number (PIN), an authorization code, a password, or other information. The information can be provided to the customer immediately, by post mailing, by email, or by another mode of transmission.

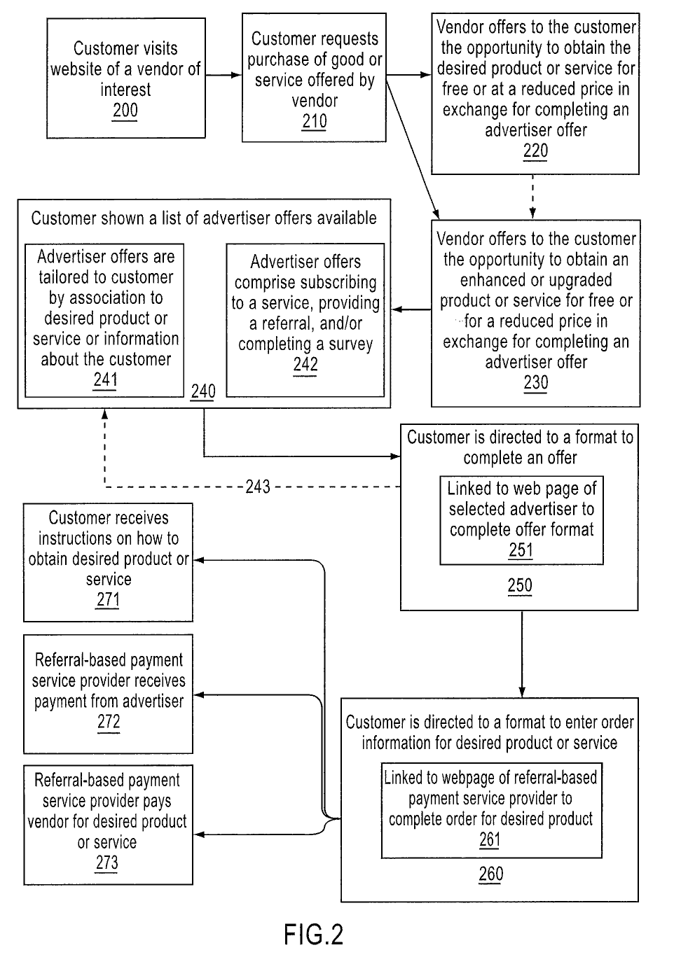

As illustrated in FIG. 2, a customer can be directed to an offer interface provided by an advertiser at a web page operated by the advertiser, 251 to complete an offer, 250. Upon completion of the offer, the advertiser can send a confirmation, for example to a vendor, or to a referral-based payment service provider. The customer can then be directed to an interface for completion of the order of the desired product or service, 260, for example wherein the interface is provided by a referral-based payment service provider, 261. Upon completion of the order, the customer can optionally be sent information to obtain the desired product or service, 271, for example a key number, a personal identification number (PIN), an authorization code, a password, or other information. The information can be provided to the customer, for example, immediately, by post mailing, by email, or by another mode of transmission. The referral-based payment service provider can receive payment from the advertiser for whom the customer completed the offer, 272. The referral-based payment service provider can pay the vendor from whom the customer ordered the product or service, 273.

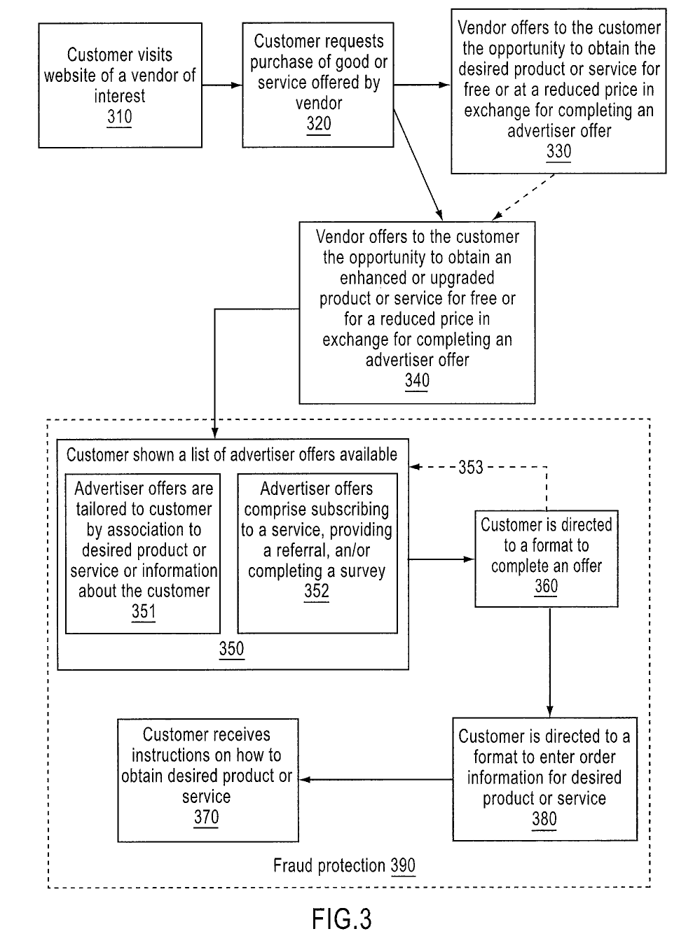

FIG. 3 illustrates an embodiment of the invention providing fraud protection 390. Fraud protection can be provided, for example, by IP address tracking provided by a referral-based payment service provider. Fraud protection can also be provided by a vendor, by an advertiser, or by any combination thereof.

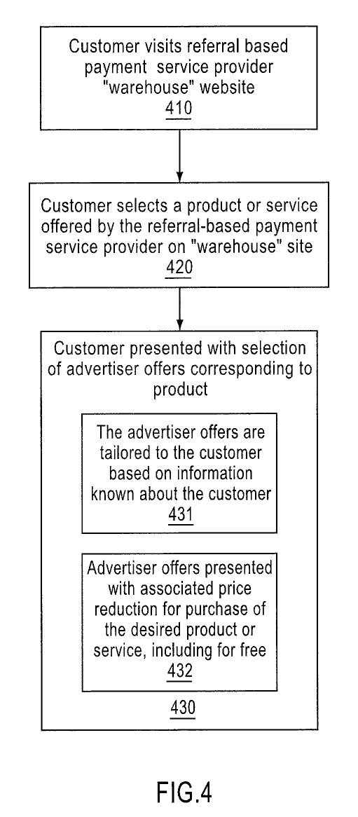

In the embodiment illustrated in FIG. 4, a customer can select a product or service for purchase directly from an offering provided by a referral-based payment service provider. In this embodiment, a customer can visit a website of the referral-based payment service provider, for example, a “warehouse” website 410, at which the customer can browse the products or services available or perform a search for a desired product or service. The customer can then select a product or service for purchase, 420. The referral-based payment service provider can offer the desired product or service to the customer for purchase, for example, at a reduced price (including offering the product or service for free), in exchange for the customer completing a corresponding advertiser offer. The referral-based payment service provider can offer the customer a selection of corresponding advertiser offers for completion, for example between 1 and 1000 advertiser offers, alternatively between 2 and 50, and for example 10 advertiser offers, 430.

The advertiser offers corresponding to the product or service desired by the customer can be tailored to the customer, for example, to the customer's preferences. Tailoring can be based upon information known about the customer 431, for example, information about the customer's past purchases, such as purchases from the referral-based payment service provider's warehouse site or another site operated by or affiliated with the referral-based payment service provider as discussed in greater detail above. In addition, the tailoring can be based on information about the customer provided from other vendors and/or advertisers.

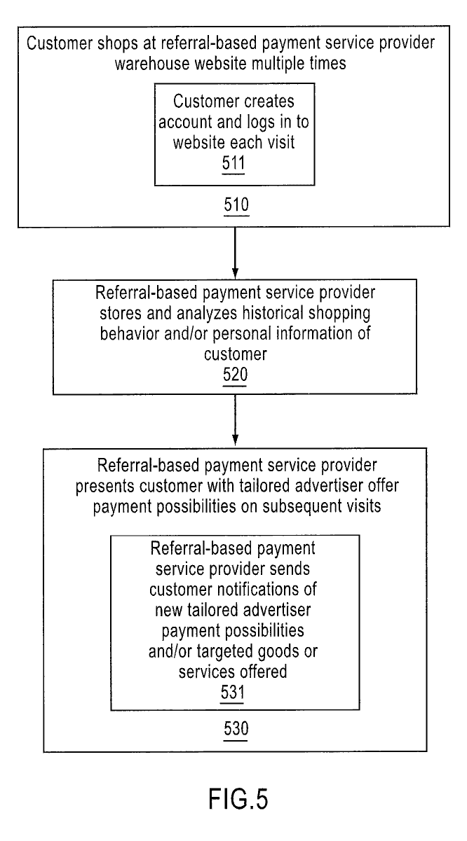

As illustrated in FIG. 5, information about the customer can be maintained in an account associated with the customer, for example, requiring the customer to log-in using corresponding account information 510 and 511. Tailoring can also be based on information known about the customer, such as personal information 520 and/or demographic information. Demographic information can be collected by the referral-based payment service provider, for example by requesting the information from the customer, such as through a survey, by receiving and storing information about a customer's shopping behavior, 520, or by collecting information provided by the customer in past transactions to advertisers as a part of completing advertising offers. A referral-based payment service can process information collected about a customer to determine the shopping preferences of the customer and present tailored advertiser offer payment possibilities on subsequent visits, 530, or later on during a single visit.

In addition, a referral-based payment service can use information collected as described in preceding paragraphs to provide notifications about offers to customers who have created an account with the referral-based payment service or an associated vendor (“registered customers”). A referral-based payment service provider can also provide notifications about offers to customers who have provided email addresses or other contact information to the referral-based payment service provider or to an associated vendor or advertiser in the past (“previous customers”). A referral-based service provider can provide notifications about offers to registered customers and/or previous customers via post mail, telephone, email, or a combination thereof. Offers sent to customers in this manner can be tailored to customer preferences, 531. A referral-based payment service provider can also send notifications to customers, registered customers, and/or previous customers, regarding products or services offered at a “warehouse” site, or offered by an associated vendor.

Advertising offers presented to the customer can be associated with corresponding price reductions for purchase of a desired product or service, for example a reduction of between 1% and 99%, or with obtaining the product or service for free as illustrated by FIG. 4, 432. Offers can be completed individually or in combination for a reduction in the purchase price. For example two or more advertiser offers can be combined to result in a combined reduction in the purchase price of the desired product or service.

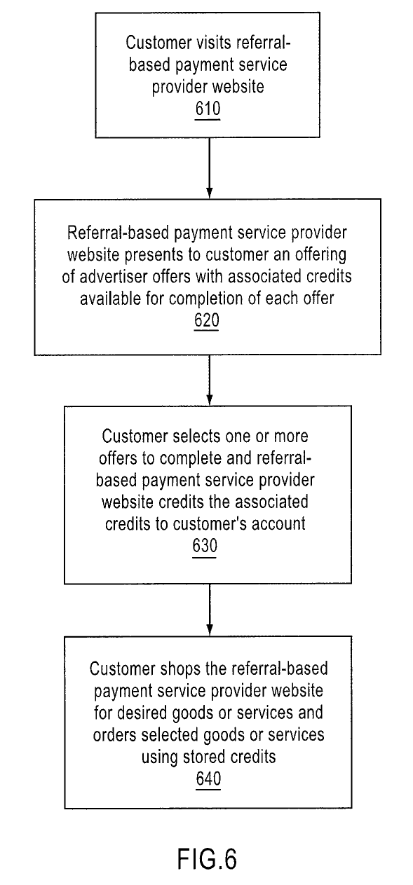

In the embodiment illustrated in FIG. 6, a customer can visit a website of a referral-based payment service provider 610 presenting a selection of advertiser offers. The advertising offers can be associated with credits obtainable upon successful completion an advertiser offer. The credits can be exchanged for products or services, for example, offered by the referral-based payment service provider 640, such as at a “warehouse” site, or exchanged for products or services offered by other vendors. Credits can be spent immediately or stored, for example, in an account associated with a customer 630, for example a registered customer. Vendors can contract with a referral-based payment service provider to accept credits issued by the referral-based payment service provider in exchange for a product or a service.

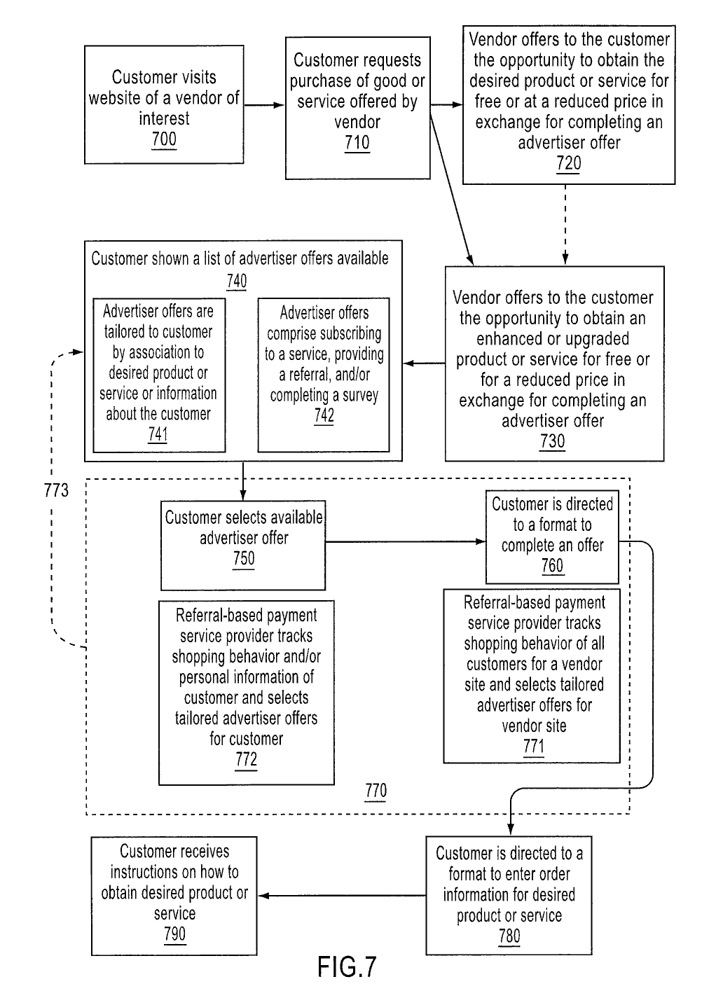

In the embodiment illustrated by FIG. 7, a referral-based payment service provider tracks information, for example personal information and/or shopping behavior, relating to customers of an associated vendor. The referral-based payment service provider can track customer personal information and customer behavior for individual customers, 771 and for all customers transacting referral-based payment business with an associated vendor, 772. The referral-based payment service provider can then use the information to “feed back” tailored advertiser offers to the associated vendor, 773, for display to subsequent customers, 740 and 741. In addition, the referral-based payment service provider can “feed back” such information to an associated vendor, 773 for the vendor's use in targeting the vendor's offerings of products and services, for example for general targeting for all customers of the associated vendor or for specific targeting for particular customers.

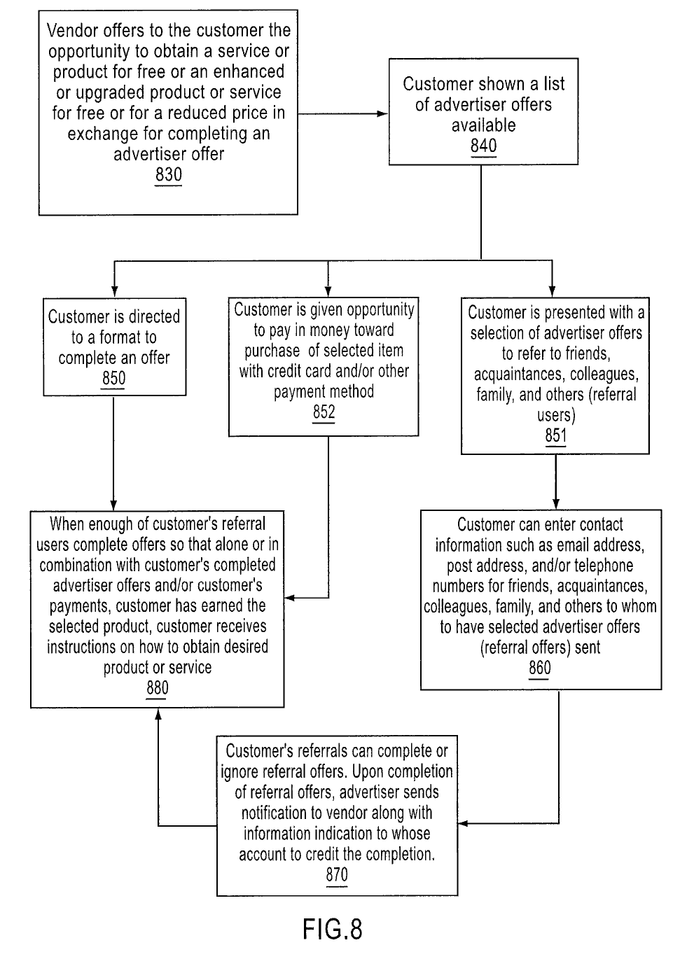

In the embodiment illustrated in FIG. 8, a customer is offered the opportunity to complete one or more advertising offers in exchange for receiving a free or reduced-price product or an upgraded model or version of an product or service already purchased from a vendor, for example, according to any of the other embodiments of the invention disclosed herein 830. If the customer indicates an interest in the offer, for example by clicking on a button on a webpage, the customer can be presented with a selection of available advertiser offers from which to choose 840. The customer can then select and be directed to advertising offers to complete, 850; can select advertising offers to have sent to referral users for completion 851 (“referral offers”); and/or may choose to directly “pay-in” amounts with a credit card or other payment method 852, for example in order to cover any balance that would remain after completion of advertising offers and/or referral offers, in order to obtain a desired product or service. If the customer selects to refer referral offers to referral users, the customer can input contact information for the desired referral user, for example a telephone number, email address, and/or a postal address 860. The customer can also indicate a personal message to accompany any referral offers to selected referral users.

Upon receipt of a referral offer, a referral user can decide whether to complete or ignore the referral offer 870. If the referral user completes the referral offer, the associated advertiser can send a corresponding notification of the completion to the vendor, including information indicating on whose behalf the referral offer was completed 870. The advertiser can also collect demographic information from a referral user and optionally transmit this information to the vendor. The demographic information can be used by the vendor, for example, to further tailor a selection of available advertiser offers and/or referral offers.

When sufficient referral offers have been completed by referral users so that, in combination with any advertising offers completed by the customer, and/or amounts directly “paid-in” by the customer, the customer is eligible to obtain a selected, desired product or service, the vendor can send notification to the customer 880, for example via email. The vendor can optionally send instructions to the customer on how obtain the product or service, for example an authorization code 880.

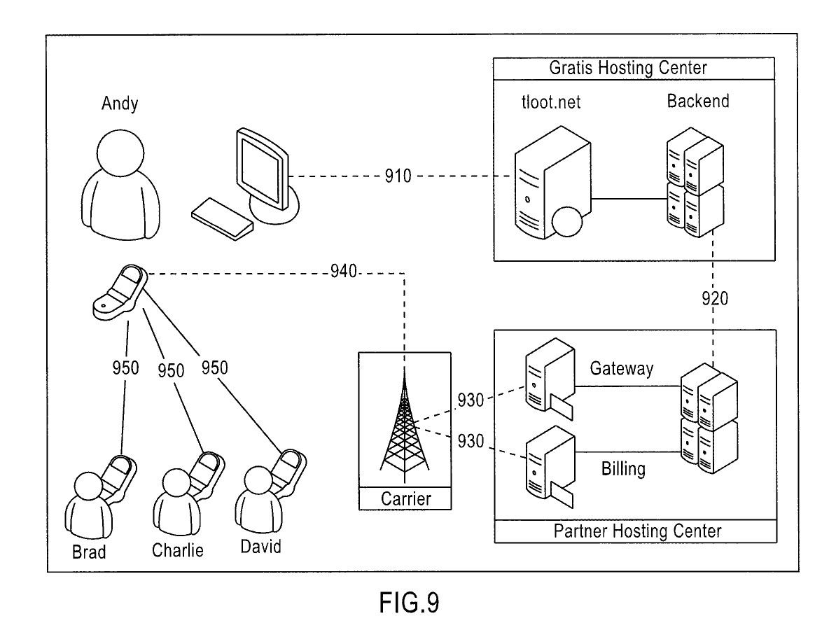

With reference first to FIG. 9, in another embodiment, mobile incentive marketing is an extension of the system described above for acquiring customers and allowing customers to earn free or otherwise reduced-price goods by exercising their purchasing power. This extension involves the combined use of the Internet and SMS text messaging. By way of example, if a user is browsing on the Internet and sees an advertisement, the user can click through to the advertiser's sign up web page.

In this example, the user, Andy, sees an advertisement for txtloot.com stating “Can u txt gd? Get a free Bluetooth headset.” Andy is then routed to the tloot.net signup page at step 910, on which he creates an account using his mobile phone number as the username. He can then choose one advertising offer in which to participate. All of the advertising offers are mobile-phone themes, including ring tone and txt service wireless offerings. Andy then reads the rules about how to claim his prize, which state that he needs to get three (or more) friends to sign up for an advertising offer as well.

The data entered by the user at the web page is transmitted to the SMS Gateway and the particular mobile phone service carrier billing partner at 920. This partner then registers the sale with the carrier's billing system, and sends a text message to the user that he can forward to his friends at 930.

Once the user receives the text message at 940, which contains his unique referral code, he can forward it to his friends at 950. The user's friends can sign up for an offer without using a computer (i.e., by using their wireless device) by texting the first, or referring, user's referral code to TLOOT [85668]. For each friend/referred user who signs up for an offer, the referral source, in this case Andy, will receive partial credit towards his incentive product. The SMS/billing partner delivers SMS messages to the carriers' networks, handles billing with the carriers, and receives messages sent to the TLOOT short code and forwards to them to the referral payment site.

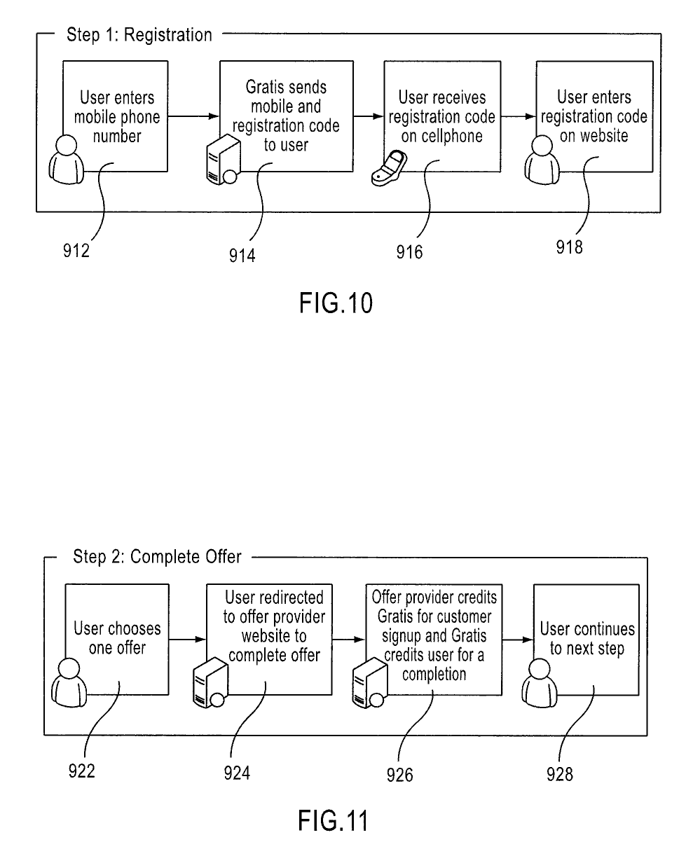

With reference to FIG. 10, a more detailed discussion of the user registration process is provided. When a user arrives at the tloot.net homepage, for example, they are prompted to join the TXTLOOT network. To do so, the user must enter their mobile telephone number on website in step 912. The user will be prompted to enter a registration code at step 914. The referral site then sends a text message with a registration code to user's handset/wireless device via SMS at step 916. The user then enters the received registration code onto the web site at step 918.

With reference to FIG. 11, after registration, the user can be presented (via a webpage) advertising offers for which they must complete one advertising offer. The user can be provided, for example, with a list of advertising offers and offer instructions. The user chooses one of the advertised offers at 922 and is then redirected to the offer provider's site to complete the offer at 924. The offer provider credits the referral site for delivering a customer and using the referral site's tracking technology the user will be credited within the referral site's backend system for completing an offer towards attaining their free incentive good at 926. The user then continues to the next step in the process at 928.

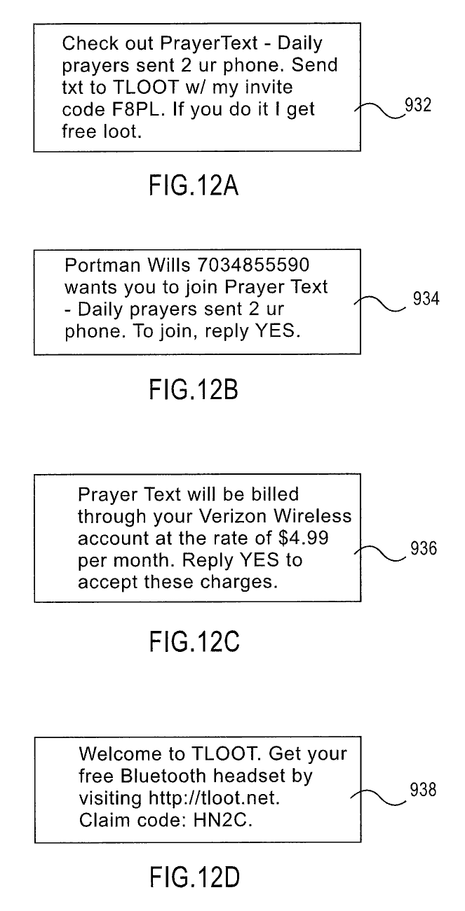

The user can next refer friends using the web or SMS text messaging. With web-based referrals, the user chooses which offer he thinks his friends will most enjoy. Those friends will then receive a text message with instructions on how to complete the offer. The referral text message could come in at least two forms: from the user or from the service.

Where the referral text message comes from the user, friends receive a text message that appears as if it came directly from the user's handset (i.e., the “from” address is the mobile number of the user). If the friend replies to the SMS, it is sent to the user. The contents of the message from the user can look like the example of a graphical user interface 932 illustrated in FIG. 12A.

If the referral text message comes from the service, friends would receive a text message that comes from, for example, 85668. The friend can reply to the message to sign up for the offer. The contents of the message from the service can look like the example of a graphical user interface 934 illustrated in FIG. 12B.

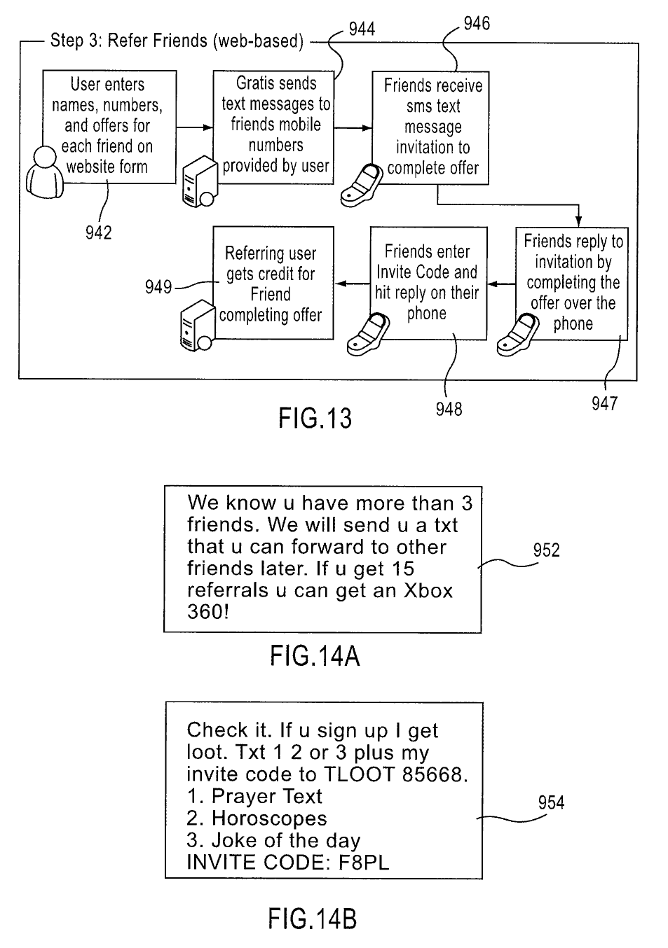

If the friend agrees to the offer, in some embodiments they will receive a confirmation message 936 as illustrated in FIG. 12C. The user may also receive an invitation to another site. In the current example, the invitation 938 could be from the web site TLOOT as illustrated in FIG. 12D. The claim code they receive allows the user to enter their tloot.net portal. Since they have already completed an offer, they will be taken directly to the Refer Friends web-based process as illustrated in FIG. 13.

Using the web-based process, the user first enters data associated with each of his friend to whom he would like to sent a referral or referrals. The user enters the names, phone numbers, and offers for each friend on a website form at 942. The referral site at 944 then sends a text message to the identified friends' mobile numbers that were provided by the user. The friends receive an SMS text message invitation to complete a predetermined offer at 946. The friends can reply to the invitation by completing the offer over the phone at 947. The friends enter the invite code they receive from the referral site and hit reply on their phone at 948. At 949, the referring user gets credit for their friend completing their offer.

The original referring user will then receive, for example, two text messages. The first message 952 in FIG. 14A can include some instructions on how txtloot works and how they can qualify for their free incentive good. The second message 954 in FIG. 14B can be a generic “forward” message that they can send to any friends that they did not enter in the web-based referral step described above.

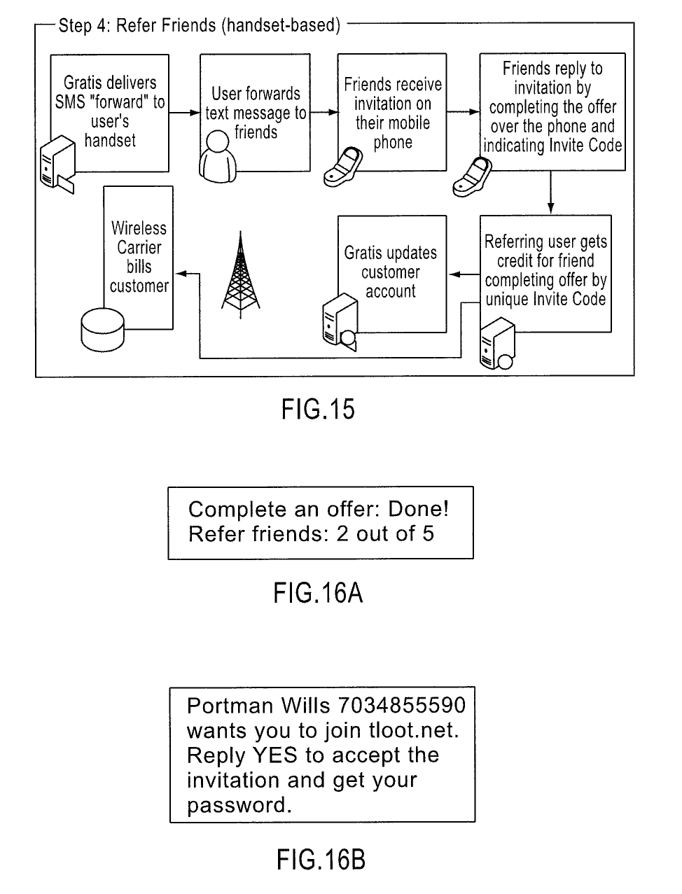

The original referring user can then forward this message to their mobile phone address book. Once user has acquired the requisite number of referrals, the company validates the offer completions and then ships the free product to the user. Referral users are then invited to also participate to earn free goods. Users are billed directly for the services they select from their wireless carriers on their wireless bill as illustrated in FIG. 15.

The TLOOT service will also allow for mobile-initiated SMS requests, and will respond with the appropriate message. Any user of tloot.net can always text the word STATUS to the TLOOT short code. They will receive a message indicating the status of their referrals as illustrated in FIG. 16A. Any user of tloot.net can always invite another person to become a member of TLOOT. If that person joins and completes an offer, it will count as a referral for the person who sent the invitation. The user sends the word INVITE plus the mobile phone number to the TLOOT short code. This will trigger an invitation message to that mobile number as illustrated in FIG. 16B. A user can send the word CANCEL to the TLOOT short code to cancel their account. They will lose any progress that they have made towards their incentive product.

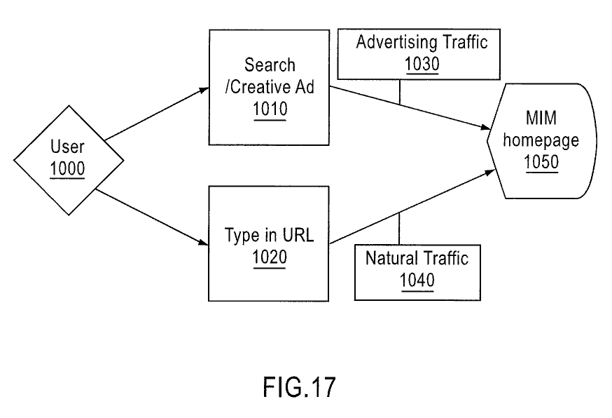

Advertisers can also offer incentives and prizes, such as, for example, iPods, to consumers for completion of advertising offers, and for referral via SMS-based text messaging of friends to do the same (Mobile Incentive Marketing or MIM). Mobile Incentive Marketing is an extension of the warehouse embodiment, described above, for acquiring customers and allowing customers to earn free goods by exercising their purchasing power. A graphical representation of the process is shown in FIG. 17. In this embodiment, an advertiser maintains a MIM homepage on the Internet to serve as a portal to the MIM service. Users access the MIM homepage either by directly inputting the MIM URL into their PC browser, or by landing at a MIM homepage after being directed through an advertisement on another web page. When the user arrives at the MIM homepage via an advertisement, this event is recorded as advertising traffic by the advertiser. Any information the publisher wishes to send, such as a publisher ID, is stored. Keyword ID can also be stored for search campaigns. When the user arrives via directly inputting the MIM Homepage URL, this is recorded as natural traffic.

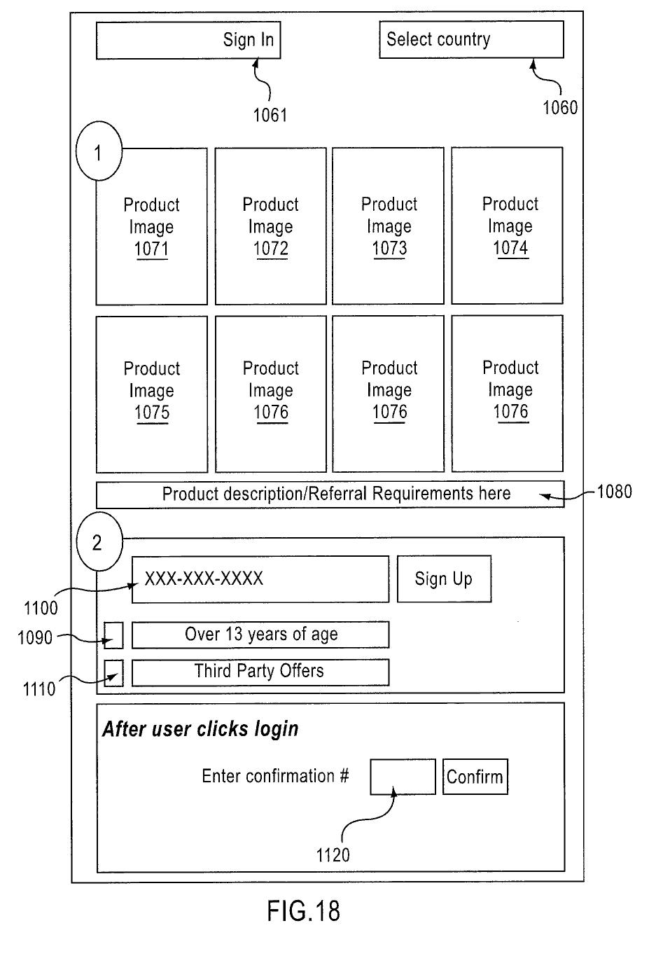

Once at the MIM home page, the user registers for participation. At the beginning of the registration/user acquisition process, the user is presented with the MIM landing page as seen in FIG. 18. Referring to FIG. 18, the user has the option to change his or her country in pull-down menu 1060. In another embodiment, the user's country will be IP detected through an IP country lookup and will be preselected and highlighted in the select country drop down box. In the embodiment of FIG. 18, eight incentive products 1071-1076 are shown on the page. In other embodiments, more or fewer incentive products can be shown. The number and types of products shown on the page is controlled via a product portfolio that is designated and biased for the particular site. Each product image represents a clickable selection for the user.

The first expected action of the user is to select a product from the portfolio. Once a user selects an item, the product description is displayed in the product description label 1080. The product description and referral requirements change dynamically as the user clicks from one product to the next. Next the user enters his or her mobile phone number in the sign up box 1100. To submit his or her mobile phone number and receive a confirmation (PIN) code, the user must have a product selected and have the age verification checkbox 1090 checked. If the product is not selected an error message will instruct the user to select one. If the age verification checkbox is not checked, an error message will instruct the user that he or she can not register unless he or she is over the age specified, and that he or she must confirm his or her age by checking the age verification checkbox before submission of their mobile phone number. By default the age verification checkbox is not checked, and the 3rd party offers opt-in checkbox 1110 is checked. The mobile phone number is validated upon submission. If the mobile phone number is not valid for the country/region where the user is, (country IP Detection) or if that mobile phone number already exists in the system, then an error message is presented to the user.

If the user's submission is successful this will trigger several events: 1) a confirmation (PIN) code is sent to the user's mobile handset; and 2) a message appears on the MIM homepage indicating that a confirmation code has been sent to the user's mobile handset and prompting the user to enter this code in the confirmation code box 1120. If the user enters an incorrect code repeatedly, an error message will be displayed and the user's account will be locked. If the user enters the correct confirmation code the following events take place: user information is stored in a mobile customer database collecting mobile phone number, product, and 3rd party offers opt-in selection and the selected product is stored in a shopping list database associating the selected product with the user. Next, a referral template SMS message is sent to the user to forward to people he or she would like to refer, such as friends or acquaintances (referrals). The referral template SMS contains products designated in a referral product portfolio. Additionally, an “offers” SMS event is queued to be sent after several days (e.g., 3 days) to the user.

Registered users click the sign in link 1061 on the MIM home page which directs them to the sign in screen. The user will enter his/her mobile phone number and PIN Code and submit his or her information. The user's submitted information will be validated. Upon a successful sign in, the user will be directed to the account page. At this point, a confirmation SMS event is sent to the mobile phone number entered by the user. If there is no mobile phone number entered, an error message prompts the user to enter it.

Once a user is registered and signs in to the MIM page, the MIM page presents the user with user information 1130 about his or her account including resident country, mobile phone number, registration date, product image, product name, product expiration date, and reward requirements. These data items are stored. The user is also presented with a number advertising offers on the MIM account page. A sign out link (not shown) logs the user out and returns them to the MIM landing page.

The number and type of offers shown to the user is based on an offer group and biasing system. The offers are represented by an offer image 1141 and offer description 1142. By clicking on either the offer image 1141 or description 1142 an associated offer page will be opened in a new browser window (not shown), and an offer click record is created. Upon an offer click, a unique identifier (SID), user's mobile number, and offer preference are passed from the MIM platform to the offer provider's landing page. If the user completes the offer, the offer provider will pass the unique identifier (SID) back to the MIM platform in a file to be uploaded via a process of the administration web site. This process will mark an offer completion for the user. An offer completion is also represented on the account page through visual notification 1160 to the user. Offer portfolios can require one offer completion or more than one offer completion by the user. An offer completion triggers the following actions: 1) an offer completion SMS is sent to the user informing the user of offer completion and referrals required; and, 2) an expiration date, for example, some number of days in the future, such as thirty or ninety, is set for the shopping list item (product).

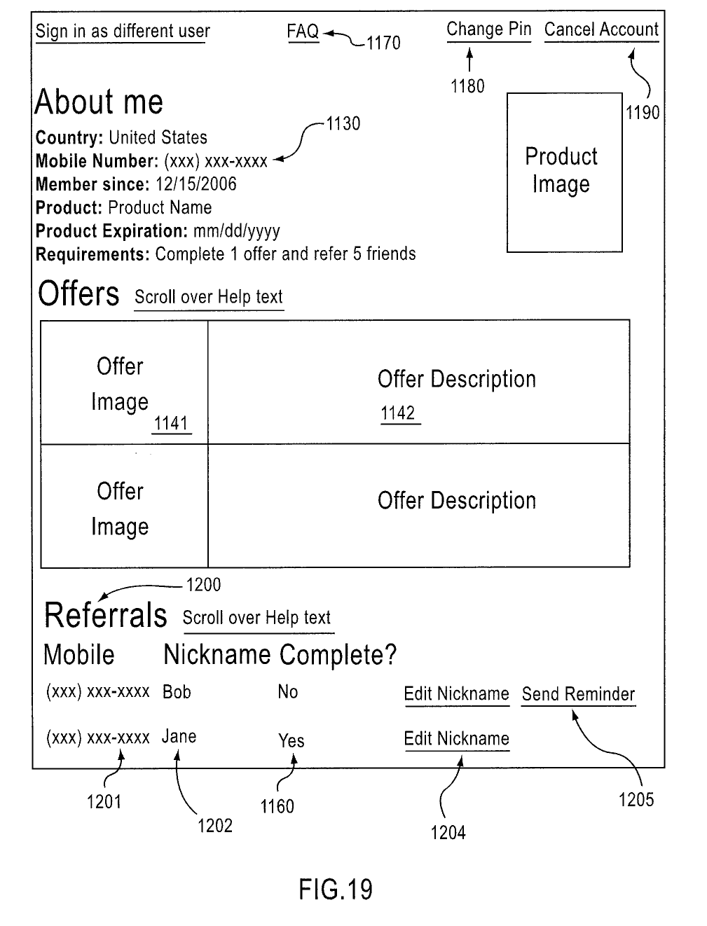

From the account status page the user can take several administrative actions. For example, referring to FIG. 19, the FAQ link 1170 directs the user to a FAQ page outlining the MIM terms & conditions and how to achieve a free product. A change pin link 1180 will present the user with a textbox to enter a new PIN and a submit button. A user can cancel his or her account using a cancel account link 1190. A confirmation message (not shown) will be presented to the user to verify cancellation of his or her account. Upon confirmation of cancellation, the user's account is not active and will no longer receive any transactional or promotional material. This user will also forfeit any progress made towards receiving a free product. The registration page can have links to the MIM terms and conditions and privacy policy. Each link will launch a new browser window with the corresponding information. In some embodiments, upon either the completion of the user registration process or upon the user exiting the landing page a pop up ad can be served to the user.

FIG. 19 further illustrates the referrals section of a user's account page. A user can view all of their referrals and their status. All referrals associated with a user are listed in the referrals section 1200 of the account page. In this embodiment, the referrals section lists the mobile phone number 1201, nickname 1202 and offer completion status 1160 of each referral. If a user does not have referrals, informative text will appear in the referrals section instructing the user to send out the referral SMS (not shown). In addition, the user can edit the nickname of each referral in his/her list by clicking the Edit Nickname link 1204. Any edit to the referral's nickname will update a database. The user can also send a reminder to each referral that has not already completed an offer requirement by clicking on a send reminder link 1205. This will trigger a referral reminder SMS event to send an SMS to the appropriate referral. In some embodiments, a user may be limited in the number and frequency of reminders allowed to be sent, for example, a reminder may be limited to every 24 hours to the same referral. In such an embodiment, if the user tries to send a reminder to the same referral within a 24 hour period he or she will receive a message indicating that he or she must wait a full 24 hours before sending an SMS to this referral again. In addition, in some embodiments, a referral can request to stop the reminder SMS Event being sent to them by texting “STOP REMINDER” to the MIM short code. The send reminder link will no longer be available for this referral.

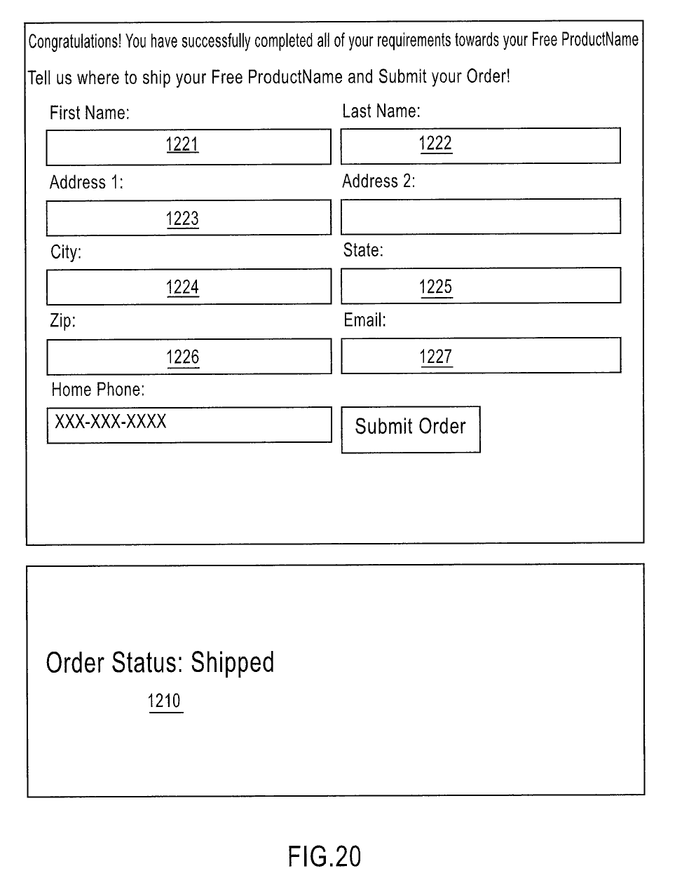

Once a user has successfully completed all of the requirements towards a free product (shopping list item) he or she will be presented with new information 1210 on the bottom of the account page, shown in FIG. 20, the next time he or she logs in. Onscreen text will reveal completion of his or her requirements toward his or her product and instruct him or her to complete his or her shipping information and submit his or her order. In some embodiments, first name 1221, last name 1222, address 1223, city 1224, state 1225, zip 1226, and email 1227 are required fields. If the user fails to enter data for any of these fields he or she will receive an incomplete data error message indicating the shipping information fields that are not completed. In some embodiments, all shipping information fields support international addresses to support use of the MIM Platform in internationally. Once the order is successfully submitted, the status of this order (shopping list item) will be updated from “fully paid” to “ordered.” The order will then appear to the administrator in an associated fulfill orders module (not shown). Additionally, the shopping history for the user will be updated to reflect the movement of the order through the queue. After the order is submitted the order status 1210 is shown and the shipping information is no longer editable. The user can log back in and check his or her order status. Once a user has ordered his or her product, he or she may select another incentive and complete offers towards it. In this embodiment, when further incentives are chosen, the user will not be shown any offers he or she has completed in the past towards other incentives.

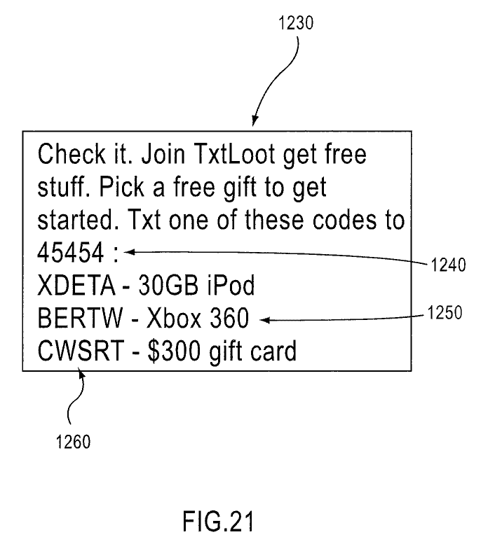

During the registration process, the user is sent a referral template message 1230. The user forwards this message to his/her friends via SMS. The message contains the MIM short code 1240 and a number of products 1250 each having an associated code 1260. The code is unique for the user and product selected. An example of the referral template SMS is shown in FIG. 21. Friends who wish to reply can send a SMS message to the designated MIM short code 1240 with the code 1260 indicating the product 1250 of their choice. The MIM platform receives the friend's SMS and registers them as a referral of the originating user based on the code 1260, assuming the user is still active. If the friend happens to send an incorrect code, the MIM platform will respond with an SMS error message to the friend and registration will not occur. In some embodiments, if the friend is already a referral of another MIM user then the friend cannot be a referral for anyone else. In one embodiment, upon successful registration of a referral the following two SMS events are triggered in succession: 1) an offers SMS event is sent providing a welcome note, “choose offer” instructions, a MIM URL linking to terms and conditions, and a list of offers to choose from; and, 2) a referral welcome SMS event informing a referral of his or her PIN code, that he or she must complete offer to get a product, and including a URL linking to MIM terms and conditions.

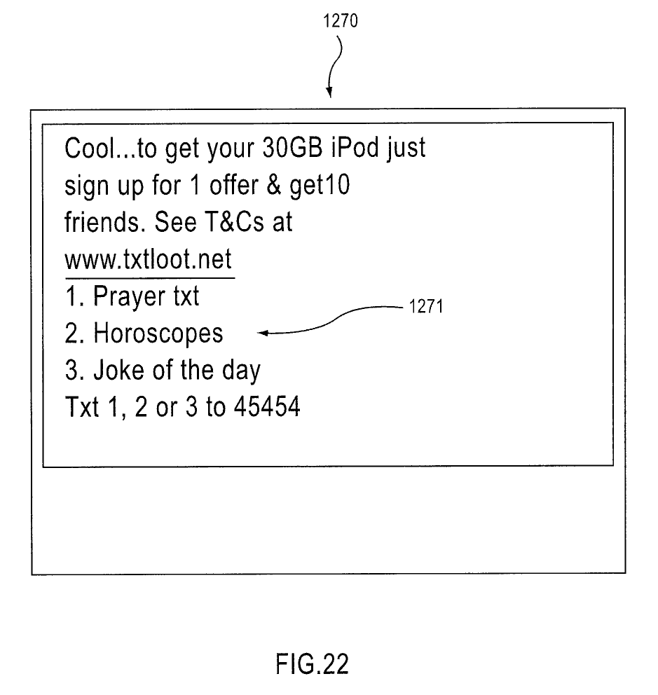

An example of a referral offers SMS message 1270 is shown in FIG. 22. After receiving the referral offers SMS message 1270, the referral replies with the number of one of the listed offers 1271 in which he or she wishes to participate. The MIM platform recognizes the referral user ID and the number of the offer and records the selection in the system. If the referral replies back with an out-of-range or incorrect number the MIM platform will respond with an incorrect data SMS error message to the referral and no selection will be recorded. Once the referral's offer choice is recorded, the MIM platform will send the appropriate offer provider, via their affiliate/partner API, the referral's mobile phone number, a unique identifier which indicates a unique offer click, and a partner/affiliate ID indicating a MIM platform lead. The offer provider accepts the lead information and sends the referral messages regarding sign-up, terms, and completion of the offer. When the referral has successfully completed the terms of the offer, the offer provider will send the MIM platform the referral's unique identifier (SID) via the affiliate/partner API. The MIM platform will record this as an offer completion for the referral. This action will trigger the following events: 1) sending an offer completion SMS to the referral informing the referral of his or her offer completion and credit, informing referral of subsequent referrals required, and informing the referral to expect another SMS message (referral template); 2) sending a referral template SMS to the referral containing a MIM description (slogan), instructions for picking a product, a code, a list of products from which to choose, and reply instructions; and 3) sending a referral completion SMS to the user indicating how many required offers are complete and how many required referrals are complete. The user only obtains credit for a referral's offer completion if the offer click date of that referral is prior to the user's shopping list item expiration date.

In addition to performing account administration tasks via a web interface, in some embodiments, a user or referral can also perform several administrative functions via SMS requests. A user or referral can text the word STATUS to the MIM platform short code at anytime triggering the referral completion status SMS event to be sent, indicating the status of offer completions and referrals. A user or referral texts the word CANCEL or STOP to the MIM platform short code at anytime triggering a cancellation of the user's account. In some embodiments, the user or referral must confirm the cancellation of their account via SMS. This will record the user or referral's account as not active. The user or referral will lose any progress he or she has made towards the incentive product. In one embodiment, a referral can text STOP REMINDER to the MIM platform to stop all reminder messages from his or her referrer.

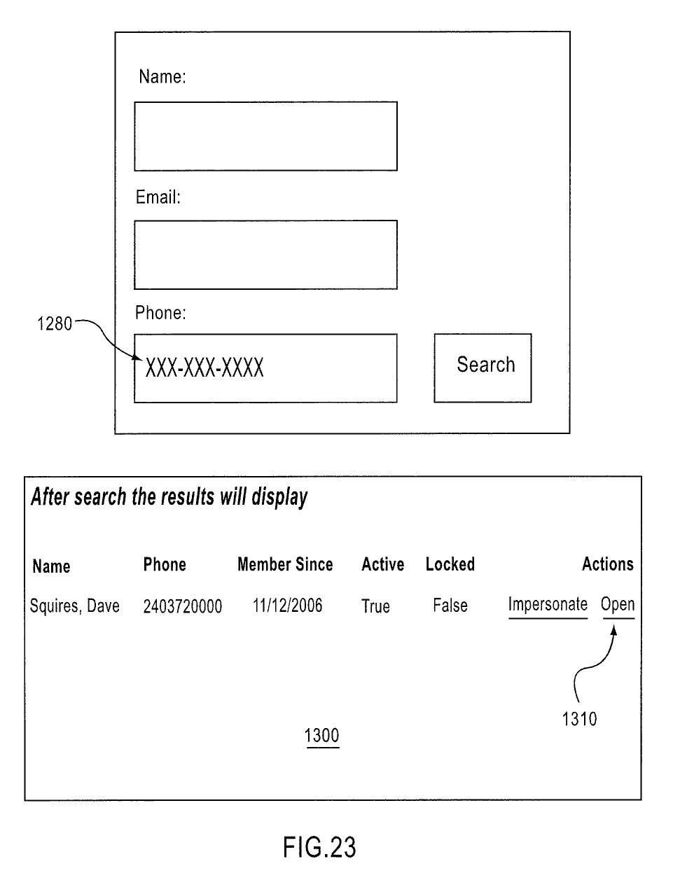

An administrator is able to manage customer accounts using management functionality including user search, view customer, fulfillment of orders, and shipment of orders functions. As illustrated in FIG. 23, in one embodiment, user search functionality is integrated with warehouse customer search. This functionality is used by the MIM administrator to search for a user. By entering the mobile phone number of the desired user in a search field 1280 and clicking the search button 1290 the user information 1300 is retrieved and displayed. In this embodiment, user information displayed in this view includes mobile phone number, registration date, confirmed user {true, false}, active user {true, false}, and locked user {true, false}. As illustrated, an “open” link 1310 is presented next to this data.

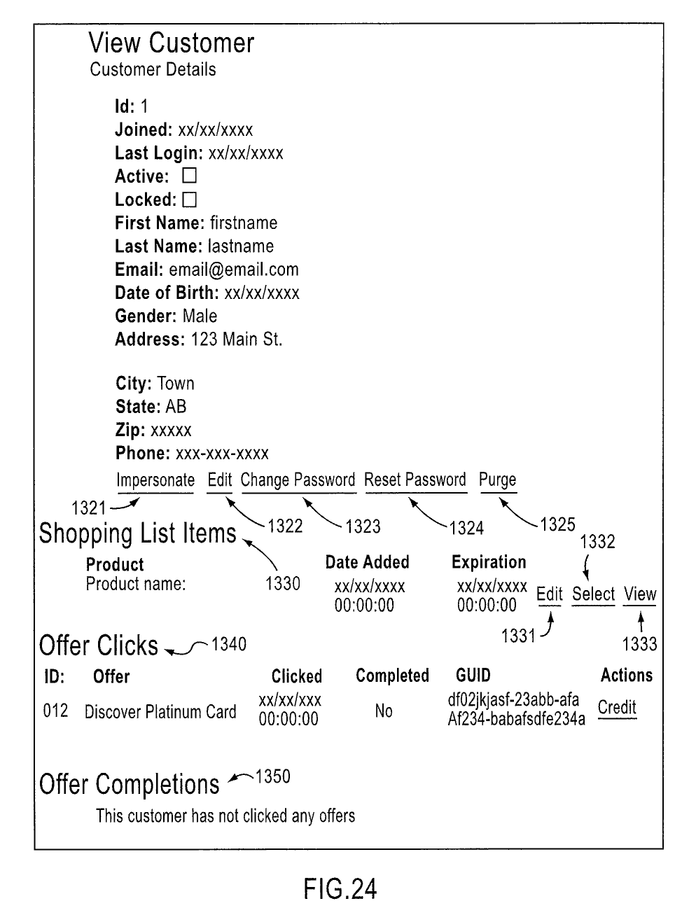

When clicked, the open link 1310 presents the view customer screen, shown in FIG. 24. In this embodiment, the following actions are available to the administrator via the associated links with respect to user account information: impersonate 1321 (log on to the MIM website as the user to allow the administrator to view the MIM website exactly how the user views it); edit 1322 (updates any of the user's personal information including first name, last name, email, DoB, gender, all address information); change password/pin 1323 (manually change a user's password/pin or generate an SMS pin reset event to user); reset password/pin 1324 (automatically reset the user's password/pin to a new, random password/pin and generate SMS pin reset event to user); SMS stop (not shown) (stops all SMS messages from the MIM platform to the user); and purge 1325 (deletes all user private information including email, DoB, phone numbers, and addresses).

The view customer view also lists the shopping list item that the user has selected, as shown in FIG. 24 under the section “Shopping List Items” 1330. In this embodiment, the product name, date product added, and product expiration are shown for the shopping list item. Additionally, the following actions are available to the administrator, via the associated links, with respect to user shopping list items: edit 1331 (add days or months to the current expiration date of a shopping list item); select 1332 (displays offer clicks and completions for a shopping list item); and view 1333 (opens shopping list item page that provides more information on this shopping list item). Another section in the view customer page is the offer clicks section 1340. Once a shopping list item is selected, offer click data for this shopping list item will be presented to the administrator. The data shown for each offer click includes offer, name, click date, completed {true, false}, and GUID (SID). In some embodiments, the administrator has the option to manually credit an offer click, turning it into an offer completion. An offer completions section 1350 lists all offer completions for a user, including the offer name, completion date, and GUID (SID).

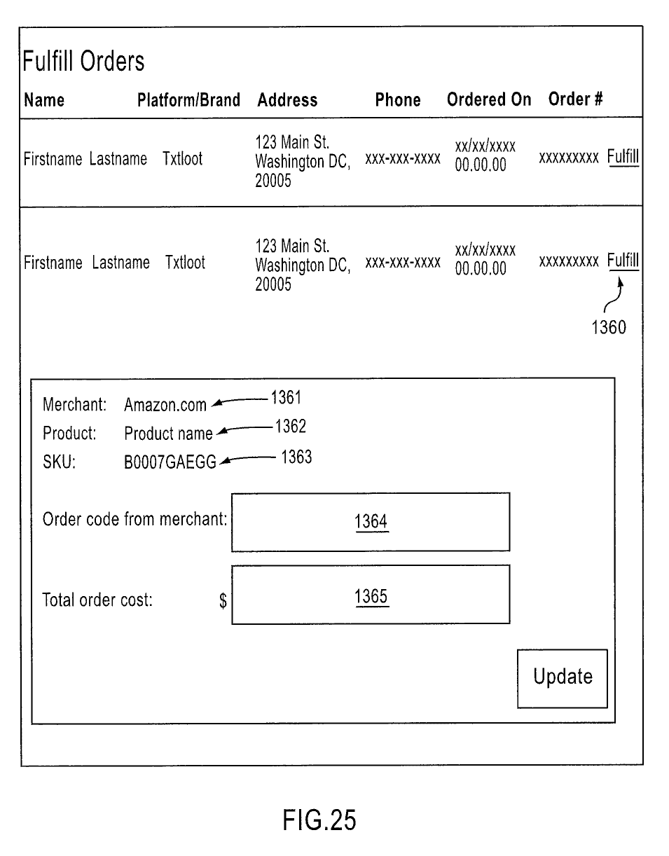

An order will be fulfilled for a particular MIM user once the user has completed all requirements associated with the associated incentive. Once the user has completed all requirements and “checked-out” from the MIM account status page his or her order will be shown in the fulfill orders screen, shown in FIG. 25. In this embodiment, the fulfill orders screen represents all orders in the queue to be fulfilled including warehouse and MIM orders. In some embodiments, warehouse orders and MIM orders are distinguished from each other. As illustrated, this listing contains the user's full name, platform/brand, full address, mobile phone and order date and is ordered by order date. When an administrator selects the fulfill link 1360 for a particular MIM order, the associated merchant name 1361, product name 1362, and SKU 1363 are shown for this user's order. In this embodiment, the administrator can enter date in the merchant order code field 1364 and total cost field 1365 for an order to update the order. The update action will move this order to the ship orders listing. This order will no longer be seen in the fulfill orders listing.

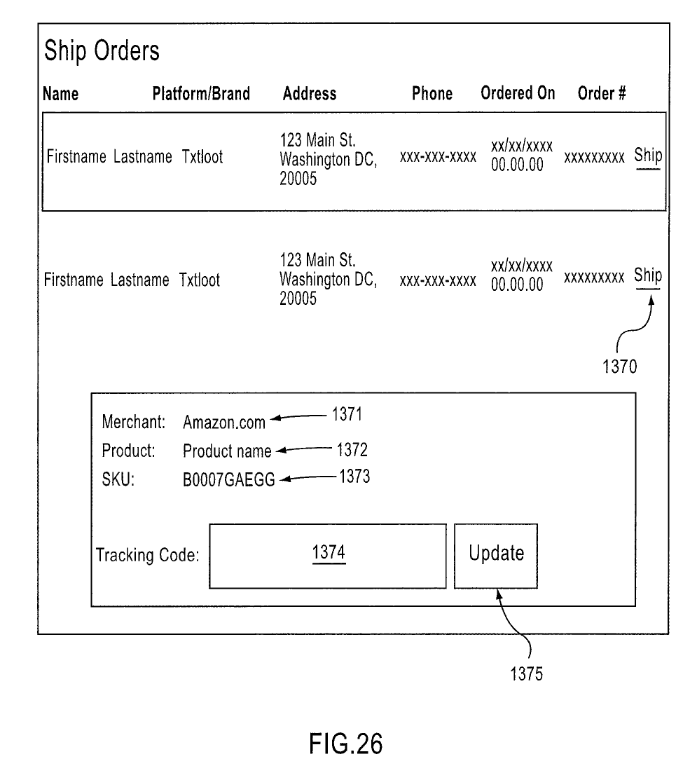

FIG. 26 illustrates the ship orders screen showing all orders waiting to be shipped including warehouse and MIM orders. As illustrated, the ship orders listing contains the user's full name, platform brand, fall address, mobile phone, order date, and order number. In this embodiment, the administrator can select a particular MIM order by clicking on the “Ship” link 1370, which displays the merchant name 1371, product name 1372, and SKU 1373 for that order. The administrator can also enter the tracking code in the tracking code field 1374 to update the order. Clicking on the update button 1375 will mark this order as shipped (status 5 to 6) and move this order out of the ship orders listing.

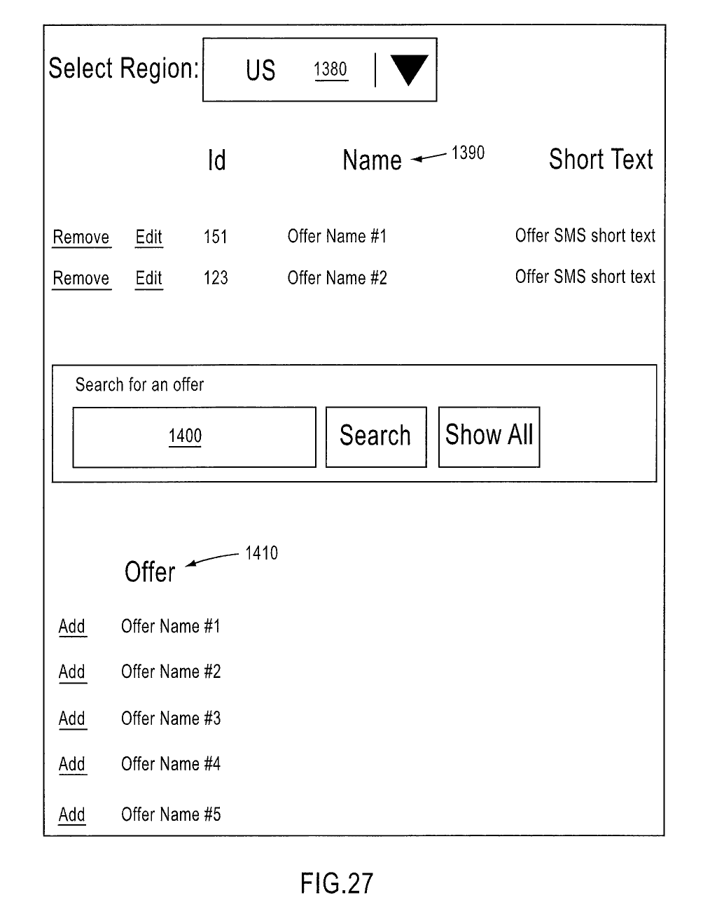

The web offer administration screen is shown in FIG. 27. The administrator manages the offers that are made available on the MIM user's account page from this screen. The administrator first selects a region from the dropdown 1380. Each region has its own associated offer portfolio. In this embodiment, the default region is the US. The screen is divided into a listing of MIM offers currently available 1390, a search for offers field 1400 and a total listing of offers from which to choose 1410. A comprehensive offers list is retrieved from the warehouse offers system for the specified region. The administrator can remove offer from the list of offers that is shown on a MIM user's account page, add warehouse system offers to the list that is shown on MIM user's account page, and search for and retrieve offers from a database. Additionally, the warehouse platform offers credit delay, which allows the administrator to assign a number of delay days to each offer individually. If there is an offer credit delay associated with an offer, the MIM platform will delay notifying the user or referral for the number of delay days specified.

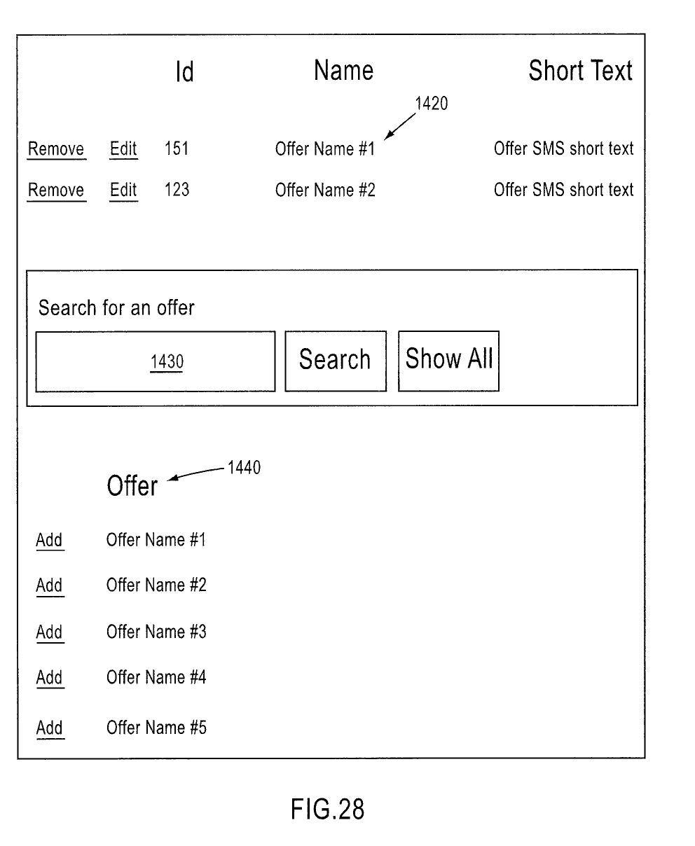

An example of an SMS offer administration screen is pictured in FIG. 28. This screen is similar to the web offer administration screen shown in FIG. 27. From the SMS offer administration screen, the administrator can manage the offers that are made available on the MIM referral's mobile phone handset. In this embodiment, the screen is divided into a listing of MIM offers currently available 1420, a search for offers field 1430 and a total listing of offers to choose from 1440. The comprehensive list of SMS offers for a specified region can be retrieved from the warehouse offers system. In some embodiments, the administrator can remove an offer from the list of offers that are shown on MIM referral's mobile handset, add a warehouse system SMS offer to the list that is shown on MIM user's account page, search for and retrieve offers from a database, and edit the offer SMS short text. Additionally, in some embodiments, the administrator can assign a number of delay days to each offer individually so that if there is an offer credit delay associated with an offer, the MIM platform will delay notifying the user/referral the specified number of delay days.

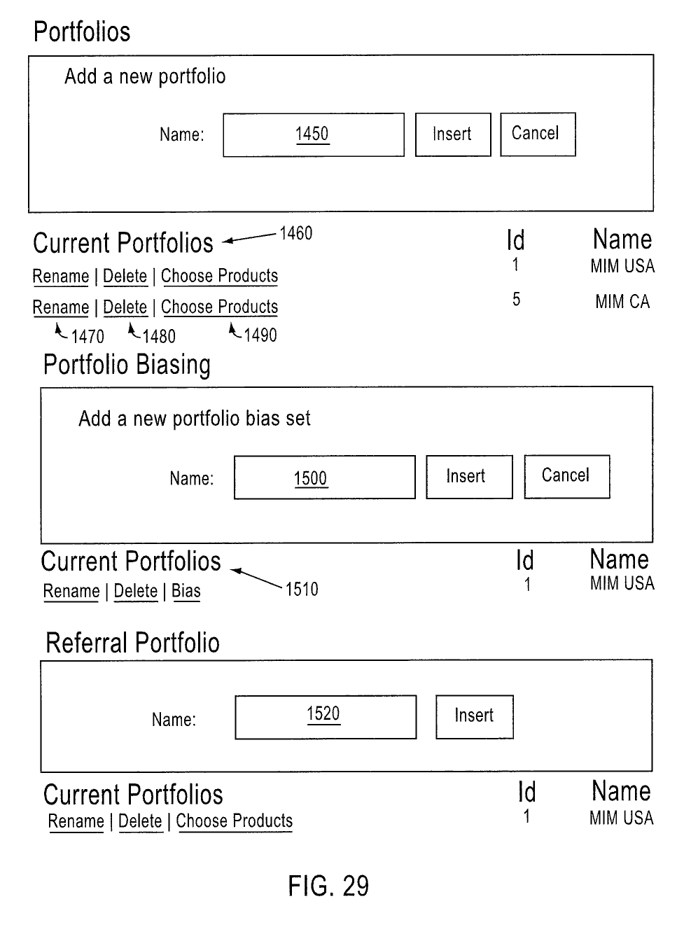

An example of a manage product portfolios screen is shown in FIG. 29. This screen allows the administrator to insert a new product portfolio via the “add a new portfolio” field 1450. Once the new product portfolio is inserted it will appear in a current portfolios list 1460. From the current portfolios list the administrator can click on the rename link 1470, delete link 1480 or choose products link 1490 for a particular product portfolio. Products chosen for a portfolio can be placed in an order (order they appear on the MIM homepage) and removed. Individual portfolios can then be added to or removed from this portfolio set and biased for a region. The administrator can bias a set of portfolios for a particular region using the “add a new portfolio bias set” field 1500. The administrator can edit the name of a current portfolio set; delete a current portfolio set; and bias a portfolio set using the corresponding links 1510. Finally, in this embodiment, the administrator can assign a referral portfolio using the insert referral portfolio field 1520. The products in each referral portfolio will be presented in each referral template SMS message that is sent out by the MIM platform. The administrator can assign several products for the referral portfolio. In some embodiments, each region has its own referral portfolio.

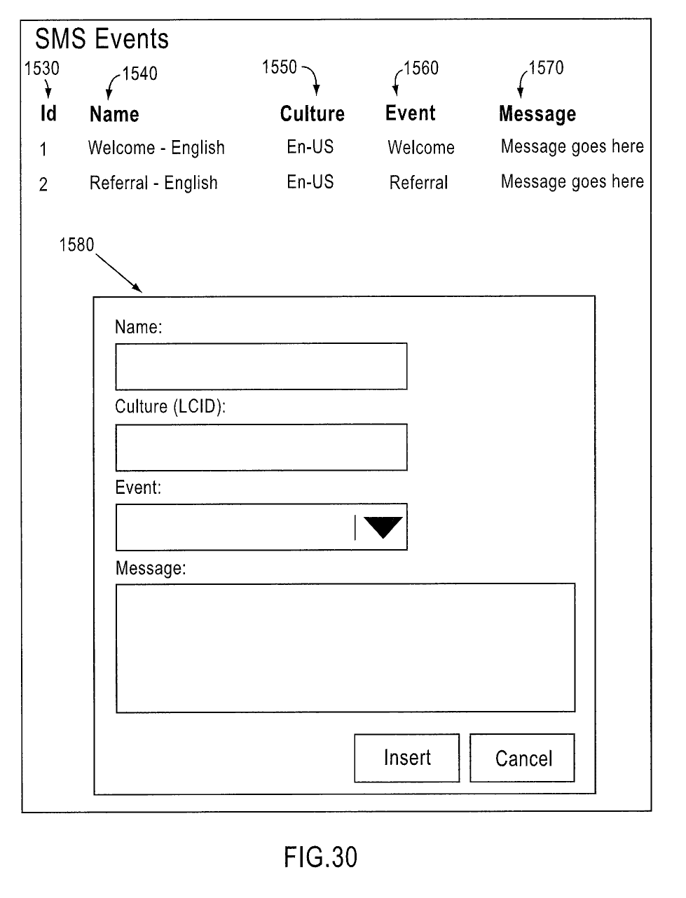

An example of an administration screen for SMS events is shown in FIG. 30. Every SMS message is associated with an SMS event. In this embodiment, the SMS events are predefined and cannot be changed. The SMS events are confirmation, referral template, referral welcome, referral offers, referral reminder, offer user completion, offer referral completion, referral completion status, and incorrect data request. In some embodiments, each SMS event can have only one SMS template message per culture. The SMS template message must have the correct number of arguments for that SMS event (i.e.: confirm code, pin code, product codes). The administrator can edit or delete any of the current SMS messages in the listing. In this embodiment, the listing shows the ID 1530, name 1540, culture 1550, event 1560 and message 1570 for each SMS event. The administrator can add a new SMS template by specifying the SMS template name, culture, event and message in the corresponding fields 1580. The following is a brief description of each SMS Event: 1) Confirmation SMS event: Informs user of confirmation pin code and informs user of STOP code; 2) Offer completion user SMS event: Informs user of their offer completion and credit, informs user of offers required and completed, and informs user of referrals required and completed; 3) Offer completion referral SMS event: informs referral of their offer completion and credit, informs referral of offers required and completed, informs referral of referrals required and completed, and informs referral to expect another SMS message (referral template); 4) Referral template SMS event: includes MIM description (slogan), pick product instructions, code, list of products to choose from, and reply instructions; 5) referral completion status SMS event: indicates number of offers completed and number of required referrals completed; 6) referral welcome SMS event: informs referral of his or her PIN code, reminds recipient that he or she must complete an offer to get a product and to expect another SMS message (referral offers), and includes a URL pointing to MIM terms and conditions; 7) offers SMS event: provides choose offer instructions, a URL pointing to MIM terms and conditions, and a list of offers to choose from; 8) referral reminder SMS event: informs referral of who the SMS is from (user), reminds the referral to complete an offer, and provides reply instructions; and 9) incorrect data request SMS event: informs user or referral that his or her request is not valid and to try again.

Among other things, an apparatus and methods for an e-commerce alternative payment system and a referral-based payment system are provided. While various embodiments of the invention have been described above, it should be understood that they have been presented by way of example only and various changes in form and details may be made. For example, all methods and systems described herein can be practiced outside the context of the Internet, for example via other media, such as television, telephone, radio, post mail, similar media, or any combination thereof.

1. A processor-readable medium storing code representing instruction to perform a process, the code comprising code to:
offer to the customer a reduction in a purchase price associated with the purchase transaction in exchange for completing an activity for an advertiser;
refer the customer to the advertiser; and
receive a redemption authorization from the advertiser.

2. A method, comprising:
offering to a customer a reduction in a purchase price associated with a purchase transaction in exchange for completing an activity for an advertiser;
referring the customer to the advertiser;
receiving a redemption authorization provided by the advertiser, and;
providing one of a product or service associated with the purchase transaction to the customer.

3. The method of claim 2, further comprising receiving a payment from the advertiser.

4. The method of claim 2, wherein the activity includes completing at least one of an advertising offer or referral.

5. The method of claim 2, further comprising directing the customer to an alternative-payment web site in order to complete the activity.

6. The method of claim 2, further comprising paying the vendor a predetermined amount of money.

7. The method of claim 2, wherein the purchase transaction is conducted on the Internet.

8. The method of claim 2, further comprising maintaining a web site featuring the product or service.

9. The method of claim 2, further comprising establishing an account associated with the customer.

10. The method of claim 2, further comprising:
receiving customer information associated with the customer;
selecting a product or a services desirable to the customer; and
displaying the selected product or service to the customer.

11. A processor-readable medium storing code representing instruction to perform a process, the code comprising code to:
advertise the sale of a product or service at least partly in exchange for the completion an activity sponsored by an advertiser;
receive a confirmation that the activity was completed, and;
receive a payment from the advertiser.

12. A method, comprising:
advertising the sale of at least one of a product or a service at least partly in exchange for completing an activity sponsored by an advertiser;
receiving a confirmation that the activity was completed; and,
receiving a payment from the advertiser.

13. The method of claim 12, wherein the receiving the confirmation includes receiving confirmation from the advertiser.

14. The method of claim 12, wherein the receiving a confirmation includes receiving confirmation from a recipient of the product or the service.

15. The method of claim 12, further comprising providing the product or the service to a customer.

16. The method of claim 12, further comprising maintaining a web site featuring the product or the service.

17. The method of claim 12, further comprising establishing an account associated with a customer.

18. The method of claim 12, further comprising:
receiving customer information associated with the customer;
selecting a product or a services desirable to the customer; and
displaying the selected product or service to the customer.

19. The method of claim 12, wherein the advertising is conducted via the Internet.

20. The method of claim 12, wherein the activity is conducted via the Internet.

21. The method of claim 12, wherein the advertising is associated with demographic information about the prospective purchaser.

22. A method, comprising:
advertising at least one of a product or a service via the Internet;
inviting a customer to a web site to create an account via the web site;
sending an SMS containing a referral code to the customer's mobile phone inviting the customer to enlist another person to register with the web site by forwarding the SMS to another person;
receiving a registration request from another person; and
crediting the account toward obtaining the product or the service.

23. The method of claim 22, further comprising:
presenting an advertising offer to the customer at the web site;
directing the visitor to an advertising offer web site to complete an activity associated with the advertising offer;
receiving a confirmation of the completion of the activity associated with the advertising offer; and
crediting the account toward obtaining a product or service.

24. The method of claim 22, further comprising:
soliciting the mobile phone number of the customer at the web site.

25. The method of claim 22, further comprising:
soliciting via the web site from the customer the mobile phone number of a third person; and
sending a text message to the mobile phone of the third person with instructions for completing an offer.
